(19) United States
(12) Patent Application Publication
(10) Pub. No.: US 2020/0215919 A1
(43) Pub. Date: Jul. 9, 2020

(54) SYSTEM FOR CONTROLLING A MAIN MONITOR OF AN AUTONOMOUS VEHICLE

(71) Applicant: PSA AUTOMOBILES SA, Poissy (FR)

(72) Inventors: Vincent LAINE, LES CLAYES SOUS BOIS (FR); Céline TACCORI DUVERGEY, MONTROUGE (FR); Felicie RAMPILLON, PARIS (FR); Stephane FERON, LE PLESSIS ROBINSON (FR)

(21) Appl. No.: 16/639,712

(22) PCT Filed: Jul. 17, 2018
(86) PCT No.: PCT/FR2018/051825

§ 371 Date: Feb. 17, 2020

(30) Foreign Application Priority Data
Aug. 24, 2017 (FR) 1757848

(51) Int. Cl. B60K 37/06; B60K 35/00; G06F 3/0488

(52) U.S. Cl. CPC B60K 37/06; B60K 35/00; G06F 3/04883; B60K 2370/175; B60K 2370/1468; B60K 2370/152; B60K 2370/1438

(57) ABSTRACT

The invention relates to a control system (2) for controlling a main monitor (10) of a motor vehicle, said control system (2), configured so as to be installed on a central console (12), comprising a display screen and a touchscreen. Said control system (2) has a first mode of operation in which said display screen is in an inactive state and the touchscreen is in a basic configuration, and a second mode of operation in which said display screen is in an active state and the touchscreen is in an advanced configuration; the control system furthermore comprises a control module configured so as to put the control system into said first mode of operation when the vehicle is in a driven driving mode or into said second mode of operation when the vehicle is in an autonomous driving mode.

### CROSS-REFERENCE TO RELATED APPLICATIONS

This application is the US National Stage under 35 USC § 371 of International Application No. PCT/FR2018/051825, filed 17 Jul. 2018 which claims priority to French Application No. 1757848 filed 24 Aug. 2017, both of which are incorporated herein by reference.

### BACKGROUND

In general, the invention relates to the field of motor vehicle displays and is intended, more particularly, to provide a control system for a display screen installed in an autonomous motor vehicle.

Currently, motor vehicles are generally equipped with a display screen positioned on the dashboard of the vehicle and enabling the display of various functionalities of the vehicle, such as a navigation system, a fuel consumption monitor or even multimedia functions.

In practice, such a display screen is controlled manually by the driver, generally by means of a series of control buttons integrated into the dashboard or by command buttons on the steering wheel. Currently, such screens also integrate, more and more, touch functionality, making it possible to both free up space on the dashboard and provide the driver or passengers with simplified access to the different functions.

Furthermore, developments related to the implementation of autonomous driving in vehicles are numerous. Today, an autonomous vehicle generally comprises, in a known manner, a mode for controlled driving and a mode for autonomous driving, the latter making it possible for the driver to not focus his attention on driving. The driver can thus easily choose the mode of driving as a function of the circumstances and of the environment of the vehicle.

When the autonomous driving mode of a vehicle is active, numerous characteristics make it possible to increase the comfort of the driver and of the passengers. Specifically, systems are known that make it possible to retract the steering wheel into the dashboard, or even to make it possible for the driver to move his seat back, so as to move away from the dashboard. However, in such configurations it is difficult for the driver of the vehicle to access the touch display screen or control buttons close to the screen or on the steering wheel.

Additionally, it is known to integrate a touch pad into the central console of the vehicle, namely into the central console of the passenger compartment of the vehicle, between the driver's seat and the passenger seat, on which is generally found a gearshift. Such a touch pad, accessible by the user regardless of the position of his seat, which is configured to be compatible with a controlled driving mode, makes it possible, by means of the simple gesture of sliding a finger, to control the display screen. In a known manner, the display screen is then configured in order to display the access buttons to a set of functions by means of icons, surrounded, for example, by a light halo, when the latter are selected. Repeated translation movements of the finger on the touch pad specifically make it possible to go from one icon to another. A touch pad is different from a display screen on which sliding movements of the finger make possible direct access from one page to another.

However, such a touch screen, generally installed on high end vehicles, has limited capacities, since it is configured to be mainly compatible with the controlled driving mode of the vehicle and thus, to only authorize simple translation movements toward the left, right, upward and downward. In addition, such limited movements require a progression between the different icons, step by step, which presents the problem of being time-consuming. Such a touch pad is thus not optimal in the case of autonomous driving of the vehicle, since it does not provide the user with rapid and simple access to a desired functionality. In addition, the functionalities accessible on the display screen via such a touch pad are also limited.

### SUMMARY

Therefore, to relieve, at least partly, these shortcomings a simple and efficient control system is proposed for a vehicle display screen, providing the user with rapid accessibility to different functions. In particular, a complete, accessible control system is provided regardless of the position of the seat in the vehicle.

More specifically, in order to achieve this result, a control system for the control of the main vehicle monitor, specifically an automobile, wherein the vehicle comprises a central console and having a controlled driving mode and an autonomous driving mode, and wherein the control system is configured to be assembled on the central console, comprises:
a display screen, with an active state and an inactive state,
a touch pad, with a basic configuration, in which the touch screen makes possible only a limited number of simple movements, and an advanced configuration, in which the touch pad is configured in order to allow control of the movement of a pointer on the main monitor.

The control system, has a first mode of operation, in which the display screen is in the inactive state and the touch pad is in its basic configuration, and a second mode of operation, in which the display screen is in the active state and the touch pad is in its advanced configuration is, wherein the control system additionally comprises a control module configured to place the control system in the first mode of operation when the vehicle is in the controlled driving mode or in the second mode of operation when the vehicle is in the autonomous mode.

Advantageously, such a control system makes it possible for the driver to have available two distinct modes of operation depending on the driving mode of the vehicle. Additionally, the control system makes possible simplified control of the main monitor when the driver's attention is required on the road and a more complete control, in the opposite case.

Advantageously, since the main monitor has a simplified display mode and a complete display mode, the control module is additionally configured to place the main monitor in the simplified display mode when the vehicle is in controlled driving mode or in the complete display mode when the vehicle is in autonomous driving mode. Two such display modes make it possible for the main monitor to be adapted to the vehicle driving mode.

Advantageously, the simple movements of the basic configuration correspond to a sliding movement to the left, a sliding movement to the right, a sliding movement downward or a sliding movement upward.

In a preferred mode, the touch pad also has an intermediate configuration in which the touch pad makes possible a limited number of simple movements combined with a handwriting recognition function, making possible the more rapid uploading of a text, even when the vehicle is in its controlled driving mode.

Advantageously, the active state of the display screen corresponds to the lighted display screen and the inactive state of the display screen corresponds to the darkened display screen or to a monochromatic background screen, making it possible to not distract the driver when the vehicle is in its controlled driving mode.

Advantageously, the display screen is configured to display a virtual touch keyboard, making possible a simpler and more rapid uploading when the vehicle is in autonomous driving mode.

Advantageously, if the vehicle comprises a secondary monitor, the control system is additionally configured to control the secondary monitor, making it possible to access both vehicle monitors with a single control system.

According to a preferred aspect, the control system is configured to control a main vehicle monitor comprising a touch screen and/or a non-touch screen.

Advantageously, the display screen and the touch pad have a size comprised between 5 and 6 inches diagonally in 16/10 or 16/9 format and are configured to be integrated into the central console longitudinally (also called portrait format) or transversally (also called landscape format).

Advantageously, the complete display mode of the main monitor has a display similar to a personal computer environment, when the vehicle is in autonomous driving mode.

Advantageously, the simplified display mode of the main monitor has a set of icons.

In a preferred mode, since the control module is configured to activate the display screen upon vehicle ignition by a driver, the display screen is configured to display a message identifying the driver of the vehicle at activation of the display screen.

Also disclosed is a method of controlling a main monitor of a vehicle by a control system comprising a display screen, a touch pad and a control module, the method comprising:
the control module detecting if the vehicle is in a controlled driving mode or an autonomous driving mode, and
the control module activating a first mode of operation of the control system in which the display screen is in an inactive state and the touch pad is in a basic configuration when the vehicle is in the controlled driving mode or activating a second mode of operation in which the display screen is in an active state and the touch pad is in an advanced configuration when the vehicle is in the autonomous driving mode.

Finally, an automobile vehicle is disclosed comprising a main monitor and a control system of such a main monitor as described above.

### DESCRIPTION OF THE FIGURES

Other characteristics and benefits of the control system will become apparent upon reading the detailed description of the embodiments of the control system, given by way of example only, and in reference to the drawings in which:

FIG. 1 is a schematic representation of an automobile vehicle and of an orthogonal mark of such a vehicle.

FIG. 2 is a schematic representation of one embodiment of a control system,

FIGS. 3A and 3B are schematic representations of two examples of positioning of a control system on a central console of the vehicle of FIG. 1,

FIG. 4 is a schematic representation of the different components of the control system of FIG. 2, and

FIG. 5 is a block diagram of a method for controlling the control system.

### DETAILED DESCRIPTION

In the detailed description below, the embodiments disclosed relate more particularly to an installation of the control system in an automobile vehicle. However, any installation in a different context, in particular in any type of vehicle, is also envisioned.

According to a preferred embodiment, an automobile vehicle 1 comprises a controlled driving mode P and an autonomous driving mode Q making it possible for the driver of the vehicle 1 to talk with other passengers or to easily access different functionalities, in order to, for example, read email or draft a document. Such an autonomous driving mode Q also makes it possible for the driver, as is known, to move his seat, for example, by moving it backward or orienting it in a direction that is different from the axis of the road.

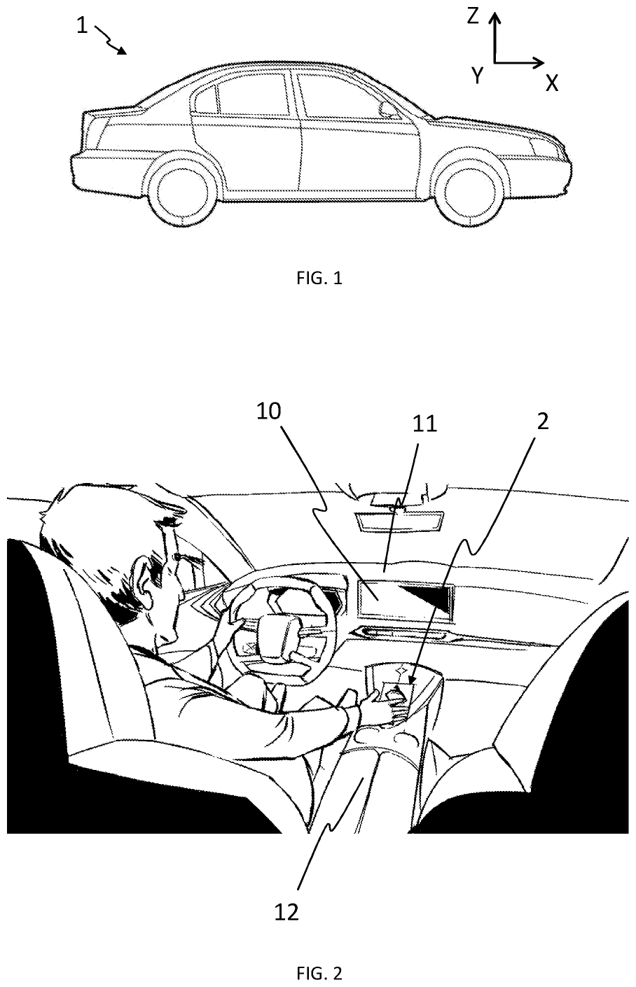

In reference to FIG. 1, the vehicle 1 extends longitudinally along an axis X, vertically along an axis Z, and transversally along an axis Y, so as to form an orthogonal mark (X, Y, Z). Thus, the term horizontal means an object extending in the plane (X,Y). Similarly, the term vertical designates an object extending in the plane (Y, Z).

Such an automobile vehicle 1 comprises, in reference to FIG. 2, a dashboard 11 and a central console 12, extending between the driver's seat and the front passenger seat. In the orthogonal mark (X, Y, Z), the central console 12 extends substantially longitudinally along axis X and transversally along axis Y in the horizontal plane (X, Y). Vehicle 1 additionally comprises a main monitor 10 and a control system 2 of the main monitor 10.

According to a preferred embodiment, the main monitor 10, positioned on the dashboard 11 of the vehicle 1, is configured to display the set of functionalities of the vehicle 1 such as a navigation system, air conditioning controls, or even a multimedia system.

Such a main monitor 10 is additionally configured to make available two distinct display modes: a simplified display mode A₀, in which the different functionalities are displayed in the form of simple icons, and a complete display mode A₁, similar to the display of a personal computer, for example, in a Windows® computer environment. Such display modes will be described in greater detail below.

The main monitor 10 is additionally configured to be controlled either manually directly on the main monitor 10, in which case, the latter comprises touch functionality, or by means of control buttons, placed on the dashboard 11 or close to the steering wheel, or by intermediary of a control system 2.

Such a control system 2, preferably mounted on the central console 12 of the vehicle 1, is effortlessly accessible by the driver of the vehicle, regardless of the position of his seat. Advantageously, the driver is thus not constrained from extending his arms to the dashboard 11 in order to control the main monitor 10.

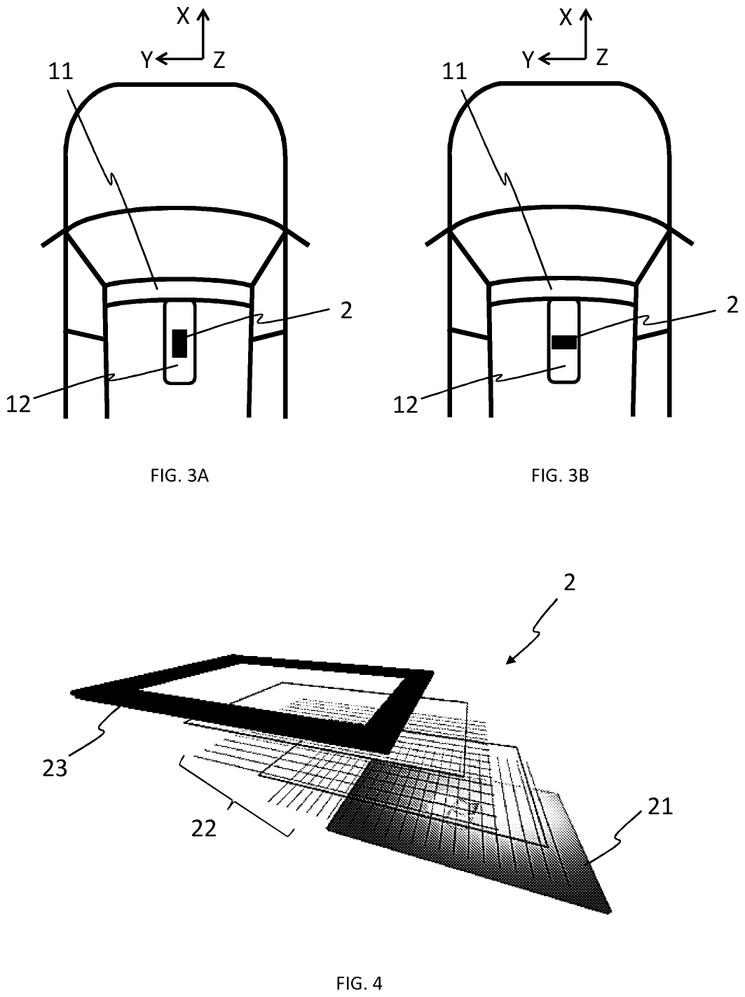

The control system 2, rectangularly shaped in this example, has a diagonal between 5 and 6 inches in length and a 16/10 or 16/9 format, providing it with dimensions similar to those of a smart phone. In reference to FIGS. 3A and 3B, such a control system 2 is thus easy to integrate into the central console 12 of the vehicle 1 and can be positioned in the substantially horizontal plane of the central console 12 along two perpendicular axes, for example, as a function of the congestion of the central console 12. In fact, the control system 2 can be positioned in the “portrait” orientation (FIG. 3A), in which the control system 2 is mounted longitudinally, that is, along the length of the central console 12, or in the “landscape” orientation (FIG. 3B), in which the control system 2 is mounted transversally on the central console 12, that is along the width of the central console 12.

In reference to FIG. 4, an embodiment of the control system 2 comprises a display screen 21 on which is mounted a touch pad 22, also designated upper layer, wherein all is covered in a protective film 23.

In this example, the display screen 21 has an active state E_{A}, in which the display screen 21 is lighted, and an inactive state E_{I}, in which the display screen 21 is darkened or displays a monochromatic background so as to limit the risks of distracting the driver when the vehicle 1 is in controlled driving mode P. Such an active E_{A}/inactive E_{I} state is configured to be activated and/or deactivated as a function of the driving mode (i.e., controlled driving mode P or the autonomous driving mode Q) of the vehicle 1, as will be described below.

When the display screen 21 is in its active state E_{A}, it is configured to display, when necessary, a virtual keyboard, so as to make it possible for the driver to enter text. Different modes of display of such a virtual keyboard will be disclosed in more detail below, depending on the orientation of the control system 2.

The touch pad 22 is similar to a touch pad used in a classic screen of a smart phone or tablet. The operation of such a touch pad 22 is known in itself and will not be described in greater detail.

According to a preferred embodiment, the touch pad 22 has a basic configuration C₀ and an advanced configuration C₁, activated as a function of the driving mode P, Q of the vehicle 1.

In fact, the basic configuration C₀ is activated preferably when the vehicle 1 is in its controlled driving mode P, during which the driver can only make simple movements, which can be executed without the need to look at the control system 2. In fact, such a basic configuration C₀ is a configuration in which the touch pad 22 allows only a limited number of simple movements, for example, a simple sliding movement of a finger to the right, to the left, upward or downward, wherein such movements are compatible with the controlled driving mode P.

Such a basic configuration C₀ is configured to be activated when the main monitor 10 is in its simplified display mode A₀, in which the different functionalities are displayed in the form of icons. The touch pad 22 then makes it possible, using simple gestures, to slide from one icon to the next, in order to access the desired functionality. A light halo can surround an active icon, making it possible for the driver to easily mark a selected icon.

The advanced configuration C₁ is activated preferably when the vehicle 1 is in its autonomous driving mode Q, during which the driver is free in his movements. In fact, such an advanced configuration C₁ is a configuration in which the touch pad 22 makes possible the control of the movement of a pointer displayed on the main monitor 10. The touch pad 22, similar to a personal computer mouse, makes it possible to move the pointer in any direction on the main monitor 10.

Such an advanced configuration C₁ is configured to be activated when the main monitor 10 is in its complete display mode A₁, in which the display of the main monitor 10 is similar to the display of a personal computer, for example, in a Windows® computer environment. The touch pad 22 then makes it possible to directly select an application or a document, for example.

Alternatively, the touch pad 22 can also have an intermediate configuration, in which the touch pad 22 allows the limited number of simple movements of the basic configuration C₀ and also comprises a handwriting recognition feature. In fact, when the vehicle 1 is in its controlled driving mode P, but the driver wishes, for example, to enter an address in the navigation system, the touch pad 22 can make it possible for the driver to trace, successively, with his finger the letters of the desired destination. The letters then display on the main monitor 10, so that the driver can control the recognition of the letters.

The control system 2 comprises a first mode of operation in which the main monitor 10 is in its simplified display mode A₀ and the touch pad 22 in its basic configuration C₀ (or in its intermediate configuration when the input of a text is necessary), and a second mode of operation, in which the main monitor 10 is in its complete display mode A₁ and the touch pad 22 in its advanced configuration C₁.

The control system 2 additionally comprises a control module (not shown) configured to place the control system 2 in the first mode of operation and the main monitor 10 in the simplified display mode A₀ when the vehicle 1 is in the controlled driving mode P, or to place the control system 2 in the second mode of operation and the main monitor 10 in the complete display mode A₁ when the vehicle 1 is in the autonomous driving mode Q. The control module, for example, the main vehicle 1 computer, is thus configured to simultaneously control the display screen 21, the touch pad 22 and the main monitor 10.

In summary, the control module is configured to detect the driving mode P, Q, of the vehicle 1 and to control:
when the vehicle 1 is in its controlled driving mode P, the first mode of operation of the control system 2, namely, to control:
   the mode of simplified display A₀ of the main monitor 10, and
   the inactive state E_{I} of the display screen 21, and
   the basic configuration C₀ of the touch pad 22, and
when the vehicle 1 is in its autonomous driving mode Q, the second mode of operation of the contrail system 2, namely, to control:
   the complete display mode A₁ of the main monitor 10,
   the active state E_{A} of the display screen 21, and
   the advanced configuration C₁ of the touch pad 22.

When the control system 2 is in the second mode of operation, the display screen 21 is additionally configured to display a virtual keyboard, making it possible for the driver to enter text as disclosed above. When the control system 2 is positioned longitudinally, in portrait orientation, then a virtual keyboard is configured to be displayed on half of the display screen 21, so as to make possible, in parallel, the movement of the pointer on the main monitor 10.

When the control system 2 is positioned transversally, in the landscape orientation, then such a virtual keyboard is configured to be displayed on all of the display screen 21, and to be able to be placed in the background when the user wishes to move the pointer on the main monitor 10. The letters on the virtual keyboard can then be deactivated or grayed-out, that is, made transparent, so as not to annoy the user.

Optionally, the control system 2 can have on the display screen 21, a welcome message when the driver enters into the vehicle 1, or even a “good-bye” message when he leaves the vehicle 1. The control system 2 can also display an identification message of recognition of the driver.

Alternatively, the vehicle 1 could also comprise a secondary monitor on the dashboard 11 making possible, for example, the displaying of data related to the vehicle 1, such as fuel consumption and speed. The control system 2 can, in such a case, be configured to control both the main monitor 10 and the secondary monitor. In the second mode of operation, the touch pad 22 of the control system 2 would then be configured to make possible the movement of the pointer between the main monitor 10 and the secondary monitor.

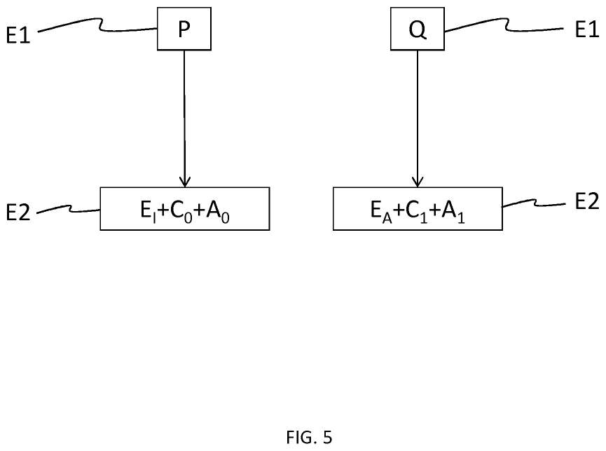

Hereafter will be presented, in reference to FIG. 5, a method for control of a main monitor 10 by a control system 2 according to a preferred embodiment.

In this example, the control module detects, in a step E1, the controlled driving mode P or the autonomous driving mode Q of the vehicle 1, making possible a step E2 of activation of the first mode of operation or of the second mode of operation of the vehicle 1.

Additionally, when the controlled driving mode P of the vehicle 1 is detected, the control module activates, in this step E2:
the inactive state E_{I} of the display screen 21,
the basic configuration C₀ of the touch pad 22, and
the mode of simplified display A₀ of the main monitor 10.

When the autonomous driving mode Q of the vehicle 1 is detected, the control module activates in this same step E2:
the active state E_{A} of the display screen 21,
the advanced configuration C₁ of the touch pad 22, and
the complete display mode A₁ of the main monitor 10.

The use of the control system 2 by the driver of the vehicle 1 is described, however, it goes without saying that the control system 2 could just as well be controlled by any occupant of the vehicle 1, for example, by a passenger.

Such a control system advantageously makes it possible to provide a display and a simple means of use when the driver is driving the vehicle and functionalities similar to a personal computer when the driver is not driving the vehicle.

1. A control system for controlling the main monitor of a vehicle, said vehicle comprising a central console and adapted to be operated in a controlled driving mode and an autonomous driving mode, wherein said control system is configured to be mounted on said central console (12), said control system comprising:
a display screen switchable between an active state (E_{A}) and an inactive state (E_{I}),
a touch pad operable in a basic configuration (C₀) in which said touch pad allows only a limited number of simple movements, and an advanced configuration in which the touch pad is configured to make possible the control of the movement of a pointer on the main monitor,
said control system having a first mode of operation in which said display screen is in the inactive state and the touch pad is in its basic configuration, and a second mode of operation in which the display screen is in said active state and the touch pad is in its advanced configuration,
said control system additionally comprising a control module configured to place the control system in said first mode of operation when the vehicle is in the controlled driving mode or to place the control system in said second mode of operation when the vehicle is in the autonomous mode of driving.

2. The control system according to the claim 1, in which the main monitor has a simplified display mode and a complete display mode, said control module is being configured to place the main monitor in said simplified display mode when the vehicle is in controlled driving mode or in said complete display mode when the vehicle is in autonomous driving mode.

3. The control system according to claim 1, in which the simple movements of the basic configuration correspond to a sliding movement to the left, a sliding movement to the right, a sliding movement downward or a sliding movement upward.

4. The control system according to claim 1, in which the touch pad also has an intermediate configuration in which said touch pad allows a limited number of simple movements combined with a handwriting recognition function.

5. The control system according to claim 1, in which the active state of the display screen corresponds to said display screen being illuminated and the inactive state of the display screen corresponds to said display screen being off or having a monochromatic background

6. The control system according to claim 1, in which the touch pad is configured to display a virtual touch keyboard.

7. The control system according to claim 1, in which, since the vehicle comprises a secondary monitor, said control system being configured to control said secondary monitor.

8. The control system according to claim 1, wherein the control system is configured to control a main monitor of the vehicle and comprises a touch screen and/or a non-touch screen.

9. A method of controlling of a main monitor of a vehicle by a control system, the control system comprising a display screen, a touch pad and a control module, said method comprising:
a step of said control module detecting whether the vehicle is in a controlled driving mode or an autonomous driving mode, and
a step of the control module activating the control system in a first mode of operation in which said display screen is in an inactive state and said touch pad is in a basic configuration when the vehicle is in said controlled driving mode, or activating the control system in a second mode of operation in which the display screen is in an active state and the touch pad is in an advanced configuration when the vehicle (1) is in said autonomous driving mode.

10. An automobile comprising a main monitor and control system of claim 1.
